(19) United States
(12) Patent Application Publication
(10) Pub. No.: US 2007/0238473 A1
(43) Pub. Date: Oct. 11, 2007

(54) Transferring information from a mobile cellular telephone

(75) Inventors: Kun Huang, Beijing (CN); Gekai Zou, Beijing (CN); Yuan Yang, Beijing (CN); Bingshan Li, Beijing (CN); Weiye Tang, Beijing (CN); Hui Yan, Beijing (CN); Lisen Xi, Beijing (CN)

Correspondence Address: HARRINGTON & SMITH, PC, 4 RESEARCH DRIVE, SHELTON, CT, 06484-6212, US

(73) Assignee: Nokia Corporation

(21) Appl. No.: 11/399,026

(22) Filed: Apr. 5, 2006

(51) Int. Cl. H04Q 7/20

(52) U.S. Cl. 455/466

(57) ABSTRACT

A mobile cellular telephone operable to automatically inform a user of the mobile cellular telephone who is remote from the mobile cellular telephone of a received, but unanswered, incoming telephone call at the mobile cellular telephone, the mobile cellular telephone including: a user interface arranged to enable the user, while the user is not remote from the mobile cellular telephone, to specify a destination address; a radio receiver for receiving an incoming telephone call; a memory for storing information relating to an incoming telephone call; and a controller operable, in response to the incoming telephone call being unanswered by the user, to create a message addressed to the specified address that includes the information stored in the memory relating to the unanswered incoming telephone call; and a radio transmitter operable to send the created message.

### FIELD OF THE INVENTION

Embodiments of the present invention relate to transferring information from a mobile cellular telephone. In particular, they relate to informing a user of a mobile cellular telephone who is remote from the mobile cellular telephone of a received, but unanswered, incoming telephone call at the mobile cellular telephone.

### BACKGROUND TO THE INVENTION

If a user forgets his or her mobile cellular telephone then they may miss an important call. This is particularly the case if a user has left the mobile cellular telephone but they work in an office. The user may have to return home to retrieve the mobile cellular telephone to make sure an important call is not missed.

### BRIEF DESCRIPTION OF THE INVENTION

According to one embodiment of the invention there is provided a mobile cellular telephone operable to automatically inform a user of the mobile cellular telephone who is remote from the mobile cellular telephone of a received, but unanswered, incoming telephone call at the mobile cellular telephone, the mobile cellular telephone comprising: a user interface arranged to enable the user, while the user is not remote from the mobile cellular telephone, to specify a destination address; a radio receiver for receiving an incoming telephone call; a memory for storing information relating to an incoming telephone call; and a controller operable, in response to the incoming telephone call being unanswered by the user, to create a message addressed to the specified address that includes the information stored in the memory relating to the unanswered incoming telephone call; and a radio transmitter operable to send the created message.

According to another embodiment of the invention there is provided a method for informing a user of a mobile cellular telephone who is remote from the mobile cellular telephone of a received, but unanswered, incoming telephone call at the mobile cellular telephone, the method comprising: a mobile cellular telephone receives user input specifying a destination address; the mobile telephone receives an incoming telephone call but does not answer the incoming telephone call; the mobile telephone stores information relating to the unanswered incoming telephone call; and subsequently, in response to the incoming telephone call being unanswered, the mobile telephone sends the stored information relating to the unanswered incoming telephone call to the specified address.

According to a further embodiment of the invention there is provided a method for transferring information from a mobile cellular telephone comprising: a mobile cellular telephone receives an incoming telephone call; and subsequently, the mobile cellular telephone sends information stored in the mobile cellular telephone to a specified destination.

According to a further embodiment of the invention there is provided a computer program comprising computer program instructions that enable a telephone to respond to an incoming telephone call being unanswered by creating a message for transmission addressed to a user-specified address that includes information relating to the unanswered incoming telephone call.

### BRIEF DESCRIPTION OF THE DRAWINGS

For a better understanding of the present invention reference will now be made by way of example only to the accompanying drawings in which:

FIG. 1 illustrates a mobile cellular telephone network comprising a mobile cellular telephone and infrastructure communicating with a computer via the Internet; and

FIG. 2 illustrates a method for informing a user of a mobile cellular telephone who is remote from the mobile cellular telephone of a received, but unanswered, incoming telephone call at the mobile cellular telephone

### DETAILED DESCRIPTION OF EMBODIMENTS OF THE INVENTION

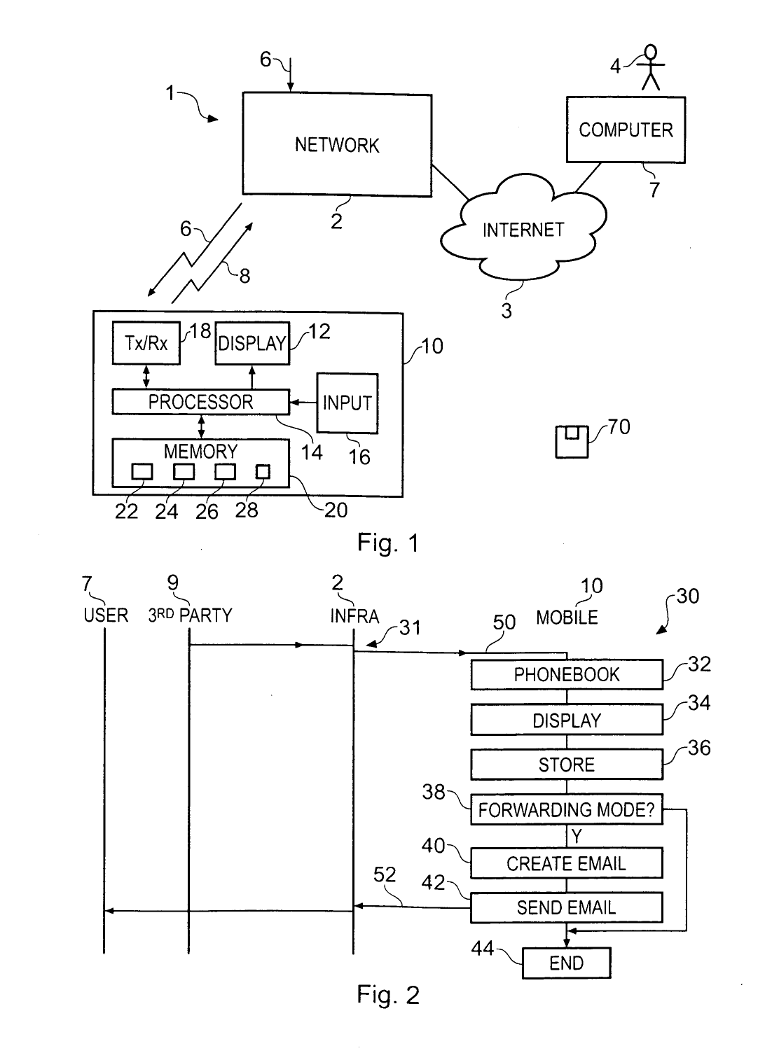

FIG. 1 illustrates a mobile cellular telephone network 1 comprising plurality of mobile cellular telephones including a mobile cellular telephone 10 and infrastructure 2.

The mobile cellular telephone 10 is operable to automatically inform a user 4 of the mobile cellular telephone 10 who is remote from the mobile cellular telephone 10 of a received, but unanswered, incoming telephone call 6 at the mobile cellular telephone 10.

The mobile cellular telephone 10 comprises a display 12, processor 14, a user input device 16, a memory 20 and a transmitter/receiver 18.

The processor 14 is connected to write to and read from the memory 20. The processor 14 is also connected to receive control signals from the user input device 16 and to provide control signals to the display 12. The radio transceiver 18 receives data from the processor 14 for transmission to the network 1 and sends data to the processor 14 that has been received from the network 1.

The memory 20 stores computer program instructions 22 that control the operation of the mobile cellular telephone 10 when loaded into the processor 14. The computer program instructions 22 provide the logic and routines that enables the electronic device to perform the methods illustrated in FIG. 2.

The computer program instructions may arrive at the mobile cellular telephone via an electromagnetic carrier signal or be copied from a physical entity 70 such as a computer program product, a memory device or a record medium such as a CD-ROM or DVD.

The memory 20 also stores a phonebook 24 that associates character strings i.e. names with respective telephone numbers.

The infrastructure 2 is operable to route a telephone call 6 made to the mobile cellular telephone 10 to the mobile cellular telephone 10 and is operable to route communications 8 made by the mobile cellular telephone 10.

In this example, the mobile cellular telephone network 1 is connected to the Internet 3. A user 4 of the mobile cellular telephone 10, who is now remote from the mobile cellular telephone 10, may use a computer 7 connected to the Internet 3 to receive information from the mobile cellular telephone 10. In the example given below, the computer 7 may be used to receive information about a telephone call 6 that has been received at the mobile cellular telephone 10 but unanswered because the user 4 is remote from the mobile cellular telephone.

FIG. 2 illustrates a method 30 for informing a user 4 of a mobile cellular telephone 10 who is remote from the mobile cellular telephone 10 of a received, but unanswered, incoming telephone call 6 at the mobile cellular telephone 10. The method 30 is performed at the mobile cellular telephone 10.

At step 31, a telephone call originated by a third party is routed to the mobile cellular telephone 10 by the infrastructure 2. The third party may use a terminal in the mobile cellular network or a terminal in a network connected to the network 2 such as a terminal in the POTS or an Internet telephone. The infrastructure 2 sends a telephone call request 50 to the mobile cellular telephone 10. The call request will typically identify the telephone number of the terminal 9 originating the telephone call.

At step 32, the mobile cellular telephone 10 receives the call request 10.

The mobile cellular telephone 10 extracts the identified telephone number from the received call request 50 and searches the phonebook 24 to find a character string, if any, associated with that telephone number.

At step 34, if a character string is found, the character string is displayed in the display 12 otherwise the identified telephone number is displayed in the display 12. An additional alert may also be provided such as a audio alert or a vibration alert to alert a user that an incoming call is being received.

If the incoming telephone call is unanswered, then at step 36, the mobile cellular telephone 10 stores the time at which the incoming call was received and the identified telephone number and/or obtained character string in its memory as a ‘missed call log’ 26. The user may access the ‘missed call log’ using input device 16 when she returns to the mobile cellular telephone 10 and discover what calls have been missed by display the log contents on display 12.

Then at step 38, the mobile cellular telephone determines whether it is an ‘information forwarding’ mode or not. If the mobile cellular telephone 10 is not in an ‘information forwarding’ mode then the method branches to step 44 and no further action is taken at the mobile cellular telephone 10. If the mobile cellular telephone 10 is in the ‘information forwarding’ mode, then the method continues to step 40.

At step 40, the processor 14 under the control of the computer program 22 creates a message addressed to a specified address 28 stored in the memory 28. The message may, for example, be an email addressed to a specified email address 28 stored in the memory 20 or an instant message or similar. The message includes in its body the information that has just been stored in the missed call log 26 i.e. the time at which the missed incoming call was received and the telephone number of the originator 9 of that call and/or a character string associated with that telephone number.

Then at step 42, the processor controls the transceiver 18 to send the message 52 to the infrastructure 2. The infrastructure sends the message to the specified destination address, which in this example is that of the user 4. The user 4 can access the message 52 from the computer 7 and is therefore given notice that a call has been missed and contact information that enables the user to phone the originator of the missed call.

The user may enable the information forwarding mode by, for example, switching the mode on via a menu of the mobile cellular telephone and specifying an address to which the created messages 52 should be sent. The address may be entered using the input device 16 or selected from the phonebook 26 using the user input device 16. Using this method, the information forwarding mode must be switched on while the user is local to the mobile cellular telephone 10.

An additional or alternative method of enabling the information forwarding mode is by sending a message to the mobile cellular telephone 10. This method enables the information forwarding mode to be activated while the user 4 is remote from the cellular mobile telephone.

The destination address may be pre-specified with the message merely switching on the information forwarding mode or the message may specify the destination address.

To prevent the unauthorized enablement of the information forwarding mode and if provided for, the unauthorized remote specification of the destination address, an authentication procedure may be performed before the mode is activated or the destination address specified.

For example, the mobile cellular telephone may only accept messages that identify the originating terminal of the message and where the identified terminal corresponds with a list of one or more authorized telephone numbers.

For example, the mobile cellular telephone 10 may only accept messages that include a password that corresponds with an authorized password.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mobile cellular telephone operable to automatically inform a user of the mobile cellular telephone who is remote from the mobile cellular telephone of a received, but unanswered, incoming telephone call at the mobile cellular telephone, the mobile cellular telephone comprising:
a user interface arranged to enable the user, while the user is not remote from the mobile cellular telephone, to specify a destination address;
a radio receiver for receiving an incoming telephone call;
a memory for storing information relating to an incoming telephone call; and
a controller operable, in response to the incoming telephone call being unanswered by the user, to create a message addressed to the specified address that includes the information stored in the memory relating to the unanswered incoming telephone call; and
a radio transmitter operable to send the created message.

2. A mobile cellular telephone as claimed in claim 1, wherein the information included in the created message comprises a time at which the incoming call was received and a telephone number identified in the received incoming telephone call.

3. A mobile cellular telephone as claimed in claim 1, wherein the memory stores a phonebook that associates character strings with respective telephone numbers and wherein the information includes a character string associated, in the phonebook, with a telephone number identified in the received incoming telephone call.

4. A method for informing a user of a mobile cellular telephone who is remote from the mobile cellular telephone of a received, but unanswered, incoming telephone call at the mobile cellular telephone, the method comprising:
a mobile cellular telephone receives user input specifying a destination address;
the mobile telephone receives an incoming telephone call but does not answer the incoming telephone call;
the mobile telephone stores information relating to the unanswered incoming telephone call; and
subsequently, in response to the incoming telephone call being unanswered, the mobile telephone sends the stored information relating to the unanswered incoming telephone call to the specified address.

5. A method as claimed in claim 4, wherein the information includes a time at which the incoming call was received.

6. A method as claimed in claim 5, wherein the information includes a telephone number identified in the received incoming telephone call.

7. A method as claimed in claim 4, wherein the information includes a telephone number identified in the received incoming telephone call.

8. A method as claimed in claim 5, wherein the information includes a character string associated, in a memory of the mobile cellular telephone, with a telephone number identified in the received incoming telephone call.

9. A method as claimed in claim 4, wherein the information includes a character string associated, in a memory of the mobile cellular telephone, with a telephone number identified in the received incoming telephone call.

10. A record medium embodying a computer program that enables a device to perform the method as claimed in claim 4.

11. A method for transferring information from a mobile cellular telephone comprising:
a mobile cellular telephone receives an incoming telephone call; and
subsequently, the mobile cellular telephone sends information stored in the mobile cellular telephone to a specified destination.

12. A method as claimed in claim 11, wherein the mobile cellular telephone sends the information to the specified destination in response to the incoming telephone call.

13. A method as claimed in claim 11, wherein the mobile cellular telephone sends the information by sending an email to a user specified email address.

14. A method as claimed in claim 11, wherein the mobile telephone receives the incoming telephone call but does not answer the incoming telephone call, the mobile telephone stores information relating to the unanswered incoming telephone call, and subsequently the mobile telephone sends the stored information relating to the unanswered incoming telephone call to the specified destination.

15. A method as claimed in claim 11, wherein the information includes a time at which the incoming call was received

16. A method as claimed in claim 11, wherein the information includes a telephone number identified in the received incoming telephone call

17. A method as claimed in claim 11, wherein the information includes a character string associated, in a memory of the mobile cellular telephone, with a telephone number identified in the received incoming telephone call.

18. A method as claimed in claim 11, wherein the destination is specified before the incoming call is received.

19. A method as claimed in claim 11, wherein user input specifies the destination.

20. A method as claimed in claim 11, wherein a received message specifies the destination.

21. A method as claimed in claim 20, wherein the received message identifies an originating telephone number which is checked against a list of one or more authorized telephone numbers before the message is used to specify the destination address.

22. A method as claimed in claim 20, wherein a received message identifies a password which is checked against a list of one or more authorized passwords before the message is used to specify the destination address.

23. A method as claimed in claim 20, wherein the received message includes an email address for use as the destination.

24. A computer program comprising computer program instructions that enable a telephone to respond to an incoming telephone call being unanswered by creating a message for transmission addressed to a user-specified address that includes information relating to the unanswered incoming telephone call.

25. A physical entity embodying the computer program claimed in claim 24.

26. The physical entity as claimed in claim 15, wherein the message created by the embodied computer program is an email.
